(19) United States
(12) Patent Application Publication
(10) Pub. No.: US 2006/0173702 A1
(43) Pub. Date: Aug. 3, 2006

(54) Network-based interaction and review service for facilitating communication in a network-based commerce environment

(76) Inventors: Ashok R. Saxena, San Jose, CA (US); Ramkumar Krishnamoorthy, Cupertino, CA (US); Peri Srinivas, Fremont, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/301,269

(22) Filed: Dec. 12, 2005

Related U.S. Application Data
(63) Continuation of application No. 09/547,784, filed on Apr. 12, 2000, now abandoned.

(51) Int. Cl. G06Q 99/00

(52) U.S. Cl. 705/1

(57) ABSTRACT

A network-based interaction and review server allows a user (e.g., a purchaser) to obtain reviews, collaboratively shop and consult experts with respect to a topic, web domain, website or product without being limited to engaging a service specific to a particular web domain, website or the network location. An interaction companion to a web browser may capture a Uniform Resource Locator (URL) of a website or web domain, currently being accessed via a web browser. This URL is communicated back into an interaction system, which performs a lookup to identify other users that are currently accessing the website or web domain, reviews relevant to the website or web domain, and experts associated with the website or web domain. The user then has the option of accessing such reviews, or engaging in communications (e.g., a web chat session or collaborative browsing) with the identified users or an expert. When engaging an expert, the expert assumes a leadership role in a collaborative browsing session. When collaboratively browsing with users, the user assumes a leadership within the collaborative session.

### RELATED APPLICATION

This application is a continuation of co-pending U.S. application Ser. No. 09/547,784, filed Apr. 12, 2000, which is incorporated herein by reference.

### FIELD OF THE INVENTION

The present invention relates generally to the field of e-commerce, more specifically to providing a network-based interaction and review service for facilitating sales advise in a network-based shopping environment.

### BACKGROUND OF THE INVENTION

Electronic commerce can occur between a potential purchaser and a supplier (or vendor) through one of many network-based systems, such as a business-to-business (B2B) exchange, an on-line auction (or reverse auction) system, a commerce-enable website, (e.g., the business-to-consumer (B2C) environment), an online information service, a bulletin board system (BBS), or between vendor and customer computers through electronic data interchange (EDI).

Typically within the B2C environment, a very small percentage of the potential purchasers visiting a vendor's network location, such as a website, convert into customers. Purchasers may hesitate to make purchases online because they do not feel knowledgeable enough about the products or services the vendor offers. To address this problem, vendors may offer online sales help services. These services include allowing a prospective buyer to communicate live with the vendor's sales staff (e.g., via a web-based chat service or telephonically by a callback service), and allowing the prospective buyer to read reviews authored by prior visitors to the vendor's website (e.g., book reviews provided by user's on the website operated by Amazon.com, Inc.).

Currently, a prospective buyer must access the websites of the vendors who sell the product that he/she wants to buy and determine the online sales services that are offered by each vendor. This can be tedious and time consuming. Also, because different vendors might offer different kinds of online sales services, it is difficult for the prospective buyer to make “apples-to-apples” comparisons of the products or services.

A number of web-based “expert” websites also provide access to experts in a number of fields. Examples of such websites include Abuzz.com, Experts.com, Experts Exchange and ExpertCentral.com to name a few. These sites provide an interface whereby a user can select a particular topic, or subject matter, whereafter the relevant service will identify one or more subscribed experts on the topic or subject matter. The user may then direct questions. These sources typically require that the user visit the relevant expert website, identify the relevant subject matter or topic to the website, and then submit specific questions via the expert website.

### SUMMARY OF THE INVENTION

This invention pertains to a method for navigating a network. A first network location accessed by a first client operated by a first user is identified by a first client component. The first network location is communicated to an interaction system. The interaction system identifies a second user associated with the first network location and facilitates a communications session between the first and second user.

Another aspect of the present invention includes the first client component communicating to a review system the first network location. The review system identifies a review data location associated with the first network location and communicates the review data location to the first client component.

Yet another aspect of the present invention includes a leader client component communicating to the interaction system a network location accessed by the leader client. The interaction system communicates the network location to a follower client component for loading the network location on a follower client.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating an exemplary network-based shopping service in the form of an Internet-based interaction and review service.

FIG. 2 shows a high-level software architectural block diagram of an exemplary client machine.

FIG. 3 shows partially one embodiment of the interaction and review service and the client component of the present invention.

FIG. 4 shows partially the resultant auxiliary client component when the user selects the “cha” option on the auxiliary client component shown in FIG. 3.

FIGS. 5A-5I is a flow chart of an exemplary interaction between the client machine and network-based the interaction and review service.

FIGS. 5J-5L are exemplary user interfaces for facilitating the interactions discussed with respect to FIGS. 5A-5I.

FIG. 6 illustrates an exemplary block diagram of a chat server daemon 614 for delivering one user's chat message to another user.

FIG. 7 is a block diagram illustrating the interaction between the leader client and follower client.

FIG. 8 illustrates an exemplary block diagram of the network-based interaction and review service for sending reviews upon request from the client machine and receiving reviews for storage from the client machine.

FIG. 9 illustrates a database table.

FIG. 10 is a block diagram illustrating an exemplary machine, in the form of a computer system, that may execute a sequence of instructions embodying the present invention and that includes a machine-readable medium for storing such a sequence of instructions.

### DETAILED DESCRIPTION

A network-based interaction and review service for facilitating purchasing advice and information in a network-based commerce environment is described in detail. In the following description, for purposes of explanation, numerous specific details are set forth in order to provide a thorough understanding of the present invention. It will be evident, however, to one skilled in the art that the present invention may be practiced without these specific details.

While the present invention is described in the context of business-to-consumer (B2C) environment, it will readily be appreciated that the present invention may be applied to a consumer-to-consumer (C2CC) environment or to a business-to-business (B2B) environment. Specifically, the present invention may be utilized to provide purchase advice and information within the context of a B2B exchange or marketplace such as those developed utilizing products of Commerce One Incorporated, i2 Technologies, Inc., VerticalNet, Inc., Ariba, Inc., FreeMarkets, Inc., or PurchasePro.com, Inc.

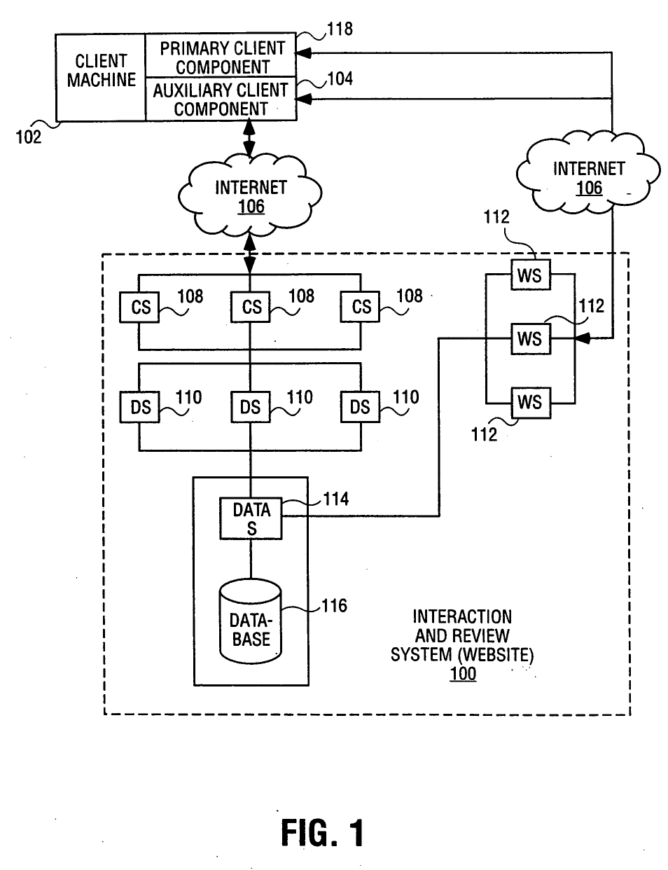

FIG. 1 is a block diagram illustrating an exemplary network-based interaction and review service in the form of an Internet-based interaction and review (I&R) system 100. The client machine 102 communicates with the system 100 via the Internet 106. The client machine 102 hosts first and second client applications in the exemplary form of primary client component 118 and an auxiliary client component 104. For one embodiment, the primary client component 118 is an Internet Explorer browser 118 distributed by the Microsoft Corporation of Redmond, Wash., and the auxiliary client component 104 is explorer bar created by utilizing the ActiveX technologies also developed by the Microsoft Corporation.

The client component 104 captures a network address (e.g., a Uniform Resource Locator (URL)) of the network location (e.g., a website of web domain) accessed by the primary client component 118. For one embodiment, the network location is a Website. The auxiliary client component 104 communicates the captured URL address to the system 100 via the Internet 106.

The system 100 provides the client machine 102 with commerce services pertinent to the URL address captured by the auxiliary client component 104. In response to the URL address received from the auxiliary 15 client component 104, the system 100 provides the client machine 102 with any of the following information:
(1) A list of experts associated with the Website identified by the URL address;
(2) A list of experts associated with the Web domain identified by the URL address;
(3) A list of prospective shoppers available for collaborative shopping associated with the Web domain identified by the URL address; and
(4) A list of review locations associated with the Website identified by the URL address.

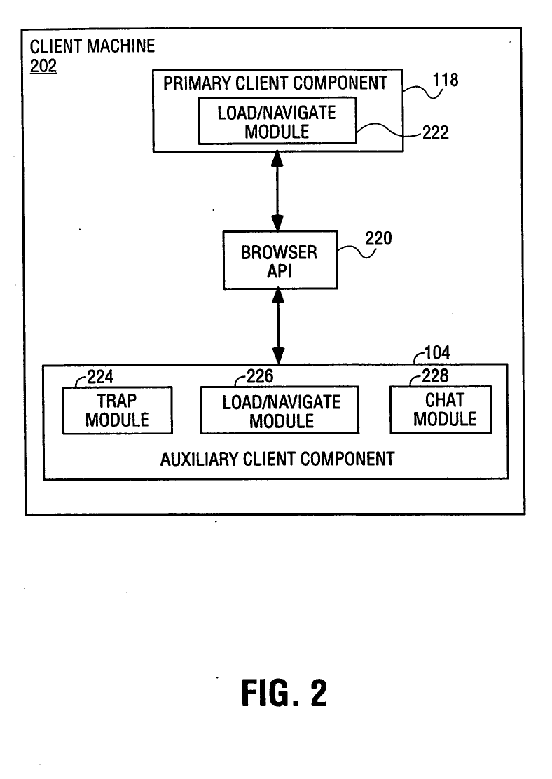

The system 100 also facilitates a chat session between a number of users and a collaborative shopping session between a number of users. These services provided by the system are discussed in detail with references to FIGS. 2-9.

The system 100 also provides other services such as facilitating the user to logon and providing the user with a list of the user's friends currently navigating the network.

To provide the above mentioned services, the system 100 includes software components such as chat servers 108, directory servers 110, web servers 112, a data server 114 and a database 116. Each chat server 108 may be an Apache server and communicates via the Internet 106 with the auxiliary client component 104. Each directory server 110 communicates with the chat servers 108 and the data server 114. Each directory server 110 also keeps the state of individual users and their chat connections as well as the state of individual chat rooms and the load on each of the chat servers 108. The web servers 112 each communicate via the Internet 106 with the primary client component 118, the auxiliary client component 104, and the data server 114. The data server 114 communicates with the database 116.

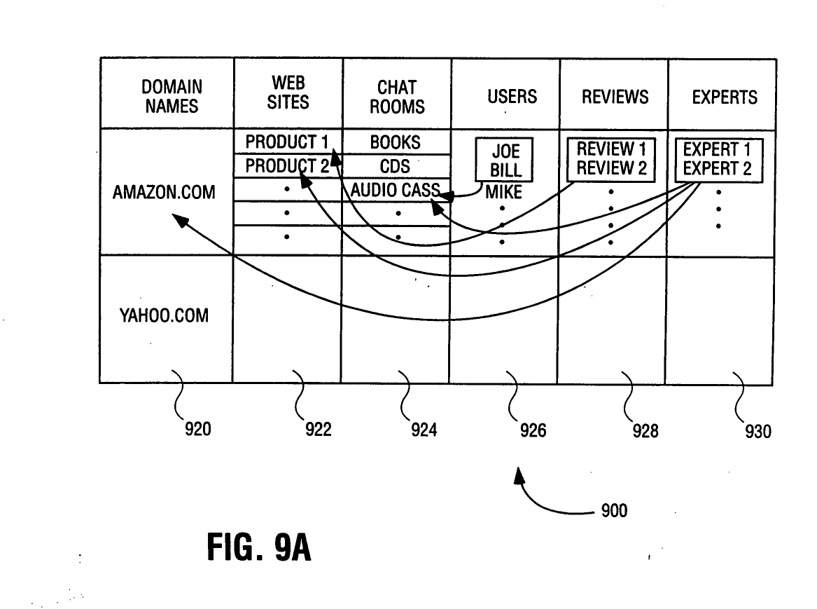

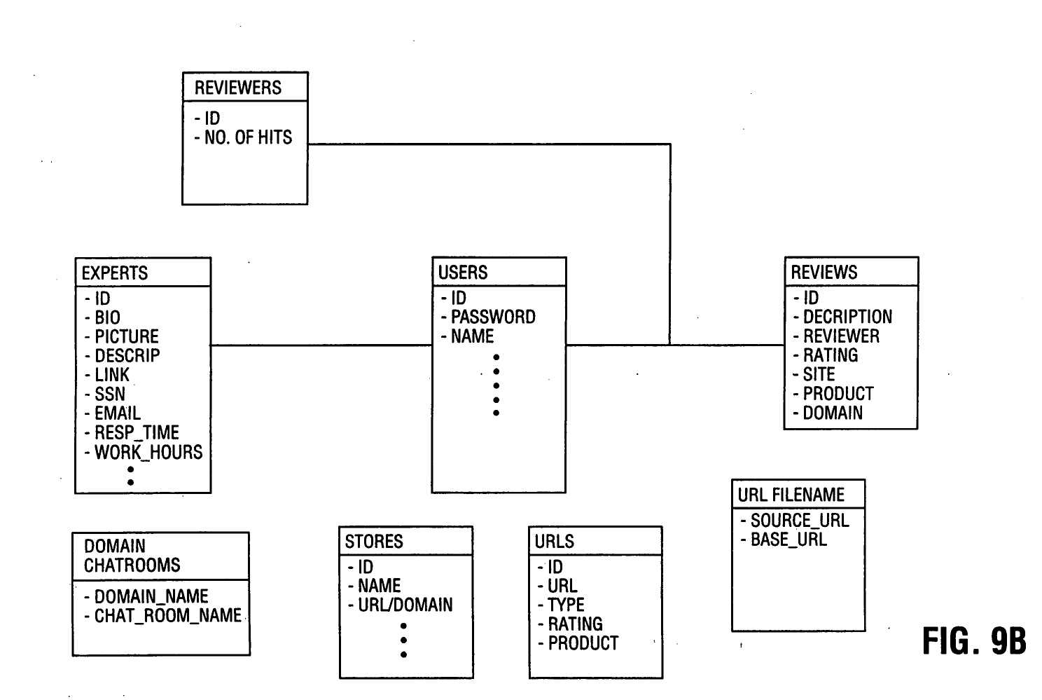

One component of the database 116 and an exemplary feature of the present invention is the domain table 900 shown in FIG. 9A. Much of the information provided by the system 100 to the client machine 102 is contained in the domain table 900. Typically, the data server 114 will match a URL address received from the auxiliary client component 104 with either the domain column 920 or the website column 922. Note that a domain can contain a number of websites. For example, the Amazom.com and Buy.com domains contain websites for multiple products (e.g., product 1 and product 2). Generally, the home page of the domain provides hyperlinks to the websites contained in the domain.

The domain table 900 is also shown to associate a number of “chat rooms” with each domain, recorded in a “chat rooms” column 924. The chat rooms are also be viewed as categories and are associated with the domains. Chat rooms associated with Amazon.com may be books, CDs and audiocassettes, for example.

The domain table 900 also records shoppers associated with the new domains. The users column 926 contains a list of users that are currently accessing the domain regardless of the Website within the domain they are accessing. For example, Joe, Bill and Mike are recorded as currently accessing a website within the domain Amazon.com.

Reviews are associated with websites and recorded within a reviews column 928 of the domain table 900. For example, review 1 and review 2 are associated with the website for product 1 contained in the Amazom.com domain.

The domain table 900 may also record the association of one or more experts with the domains, the websites and also with the chat rooms, in the expert column 930 of the domain table 900. For example, expert 1 may recorded as an expert on the amazon domain and Website for product 1 contained in the Amazon domain, and expert 2 may be recorded an expert on a “books” chat room (i.e., a book category) regardless of the domain.

While the various columns 920-930 shown in FIG. 9A are shown to be embodied within a single domain table 900, it will readily be appreciated by those skilled in database design that the domain, website, chat room, shopper, review and expert information may be distributed over any number of tables, for example in a relational database, or objects within an object-oriented database. An example of such an alternative embodiment for a database structure is shown in FIG. 9B.

Upon request from the client machine 102, the system 100 can communicate data, or subset of the data, from the domain table 900. For example, the client machine 102 can request a list of the users (e.g., shoppers) accessing a certain domain that are not in any private or public chat rooms. In this case, the requested list is a subset of the list in the users column 926 of the domain table 900. The directory server 110 can create this subset with help from the data server 114. It will be obvious to one skilled in the art of providing Internet service that countless such subsets can be created depending on the user's request.

FIG. 2 shows a high-level software architectural block diagram of the client applications hosted on an exemplary client machine 202. These client applications include a primary client component 118, an application program interface (API) 220, and an auxiliary client component 104.

The primary client component 118 may be a browser (e.g., the Internet Explorer distributed by the Microsoft Corporation of Redmond, Wash.). The primary client component 118 includes a load/navigate module 222 for accessing various network locations such as Websites. The load/navigate module 222 receives the Uniform Resource Locator (URL) address for the network location to be accessed either from user input (e.g., selection of a hyperlink or typed input), from a storage location (e.g., a home page) or from the load/navigate module 226 of the auxiliary client component 104. The load/navigate module 222 of the primary client component 118 accesses the network locations of the system 100 by communicating the URL address to the web server 112.

The client component 104 is developed utilizing the ActiveX technologies also developed by the Microsoft Corporation. The client component 104 includes a trap module 224, a load/navigate module 226 and a chat module 228.

The trap module 224 identifies and captures the URL address of the Website currently accessed by the primary client component 118.

The load/navigate module 226 performs two functions. It communicates the URL address captured by the trap module 224 to the system 100 or retrieves, from the system 100, the URL address of the network location for loading onto the primary client component 118. The chat module 228 facilitates communication between a plurality of auxiliary client components 204 operated by a plurality of users. The concept of online chat between a plurality of users is well known and is not described in detail for the sake of brevity.

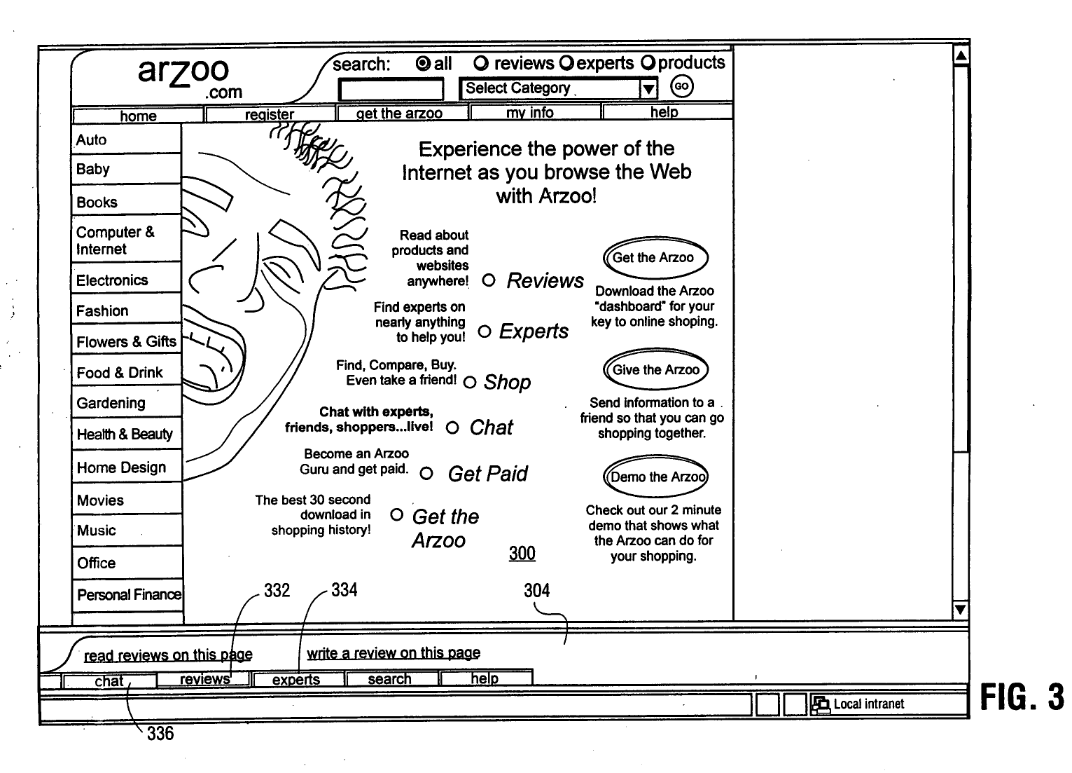

FIG. 3 shows exemplary embodiments of primary and interaction interfaces 300 and 304 that may be presented by the respective primary and auxiliary client components 118 and 104. The interaction interface 304 may be known as the “dashboard”. The auxiliary client component 104 may be downloaded on the client machine 202 by selecting the “Get the Arzoo” 330 button from the website presented in the primary interface 300. Once downloaded, the component 104 generates the interaction interface 304 that is displayed on the client machine 202 regardless of the network location accessed by the primary client component 118. The auxiliary client component 104 may be Internet Explorer bar developed utilizing the ActiveX technologies.

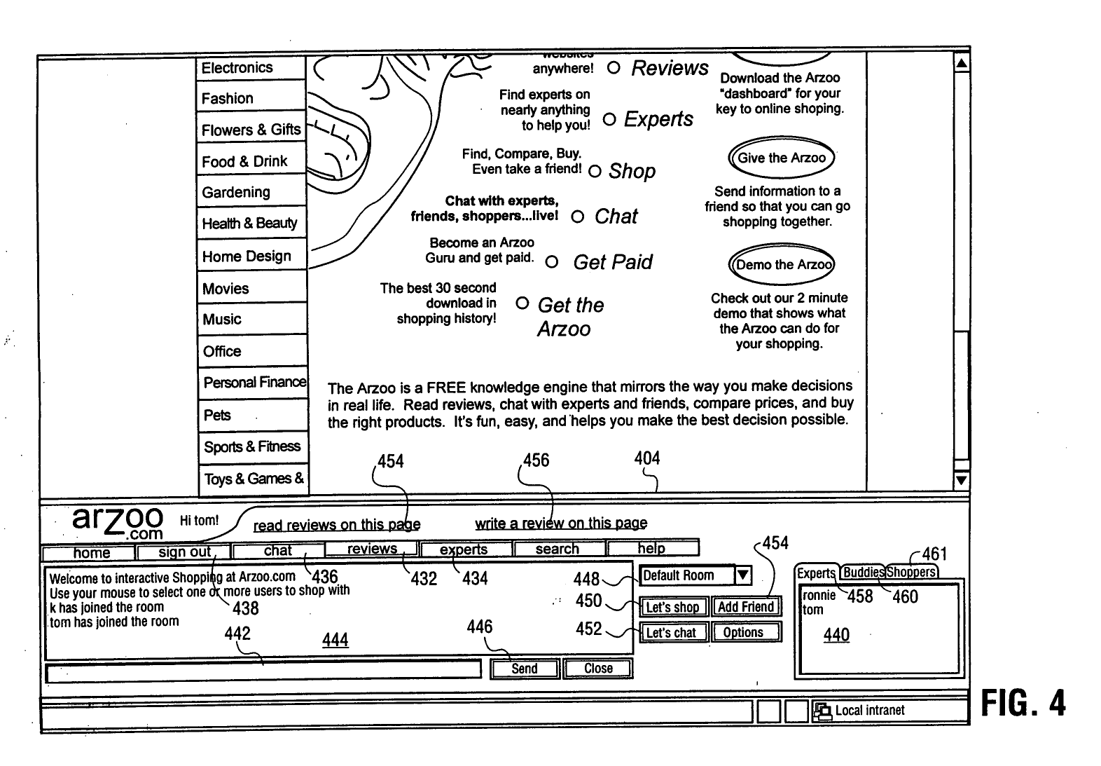

FIG. 4 shows partially the interaction interface 404, generated by the auxiliary client component 104, when the user selects the “chat” button 336 on the interaction interface 304 of FIG. 3. Note that the windows 440, 442 and 444 are not visible in FIG. 3. The interaction interface 404 offers the user options such as “sign out” 438, “reviews” 432, “experts” 434, “send” 446, “Default room” 448, “Let's shop” 450, “Let's chat” 452, “Add Friend” 454, 5 “Experts” 458, “Buddies” 460, and shoppers (not shown). These options allow the user to utilize the interaction interface 404 to request and receive information from system 100. These options also allow the user to utilize the interaction interface 404 and the system 100 to chat and perform collaborative shopping sessions

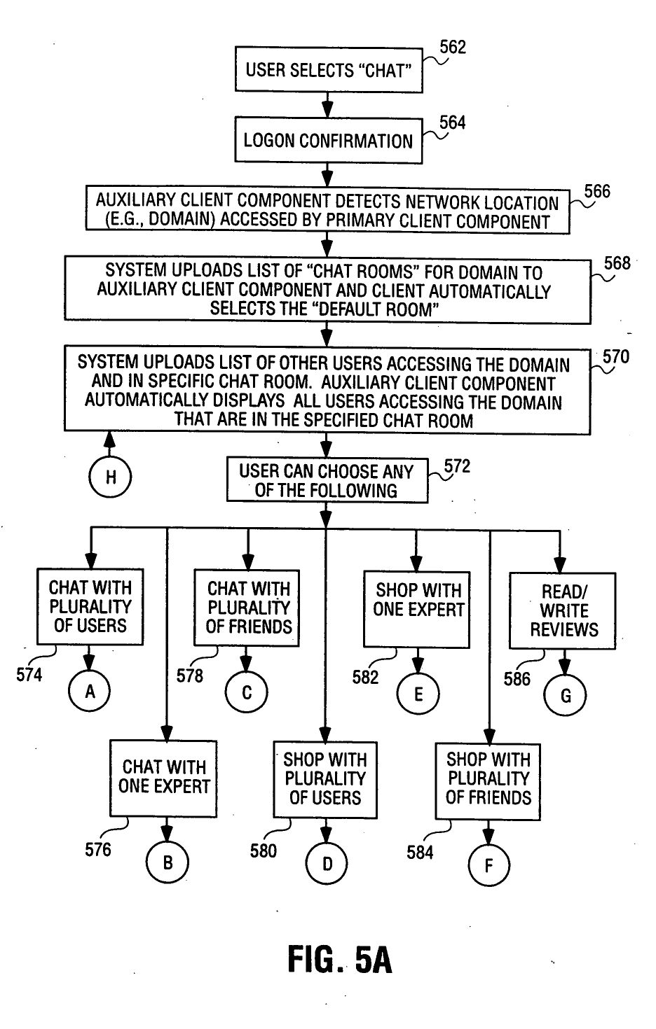

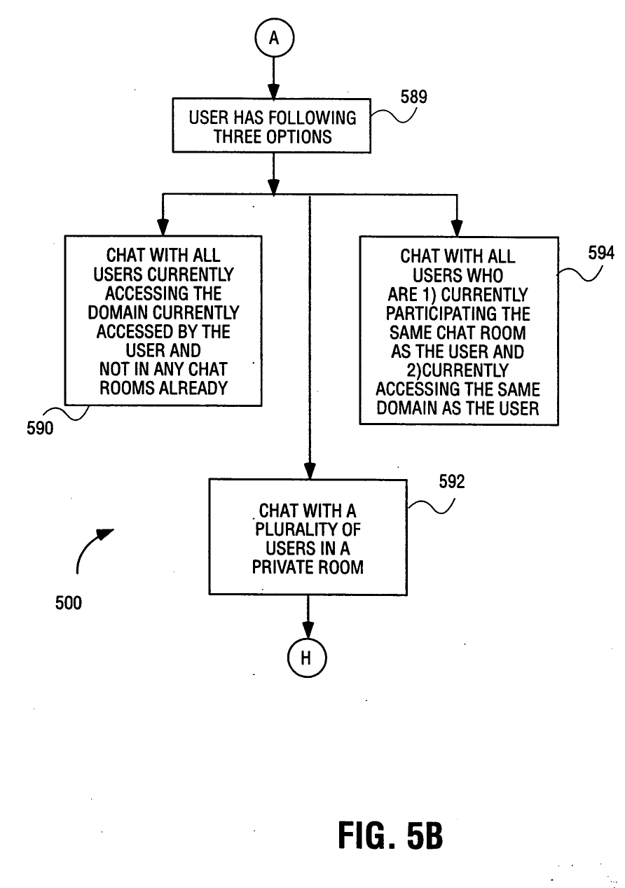

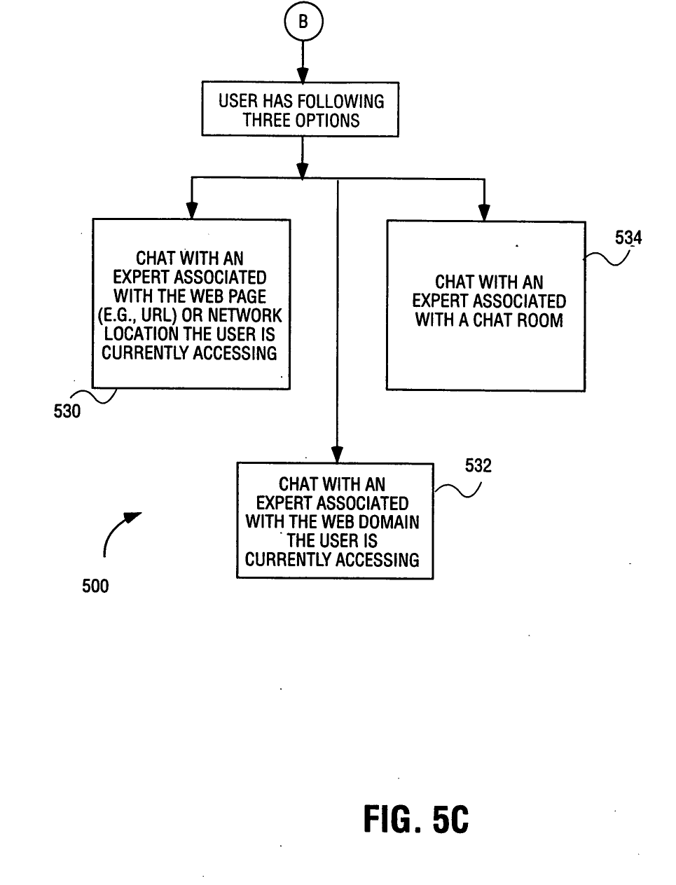

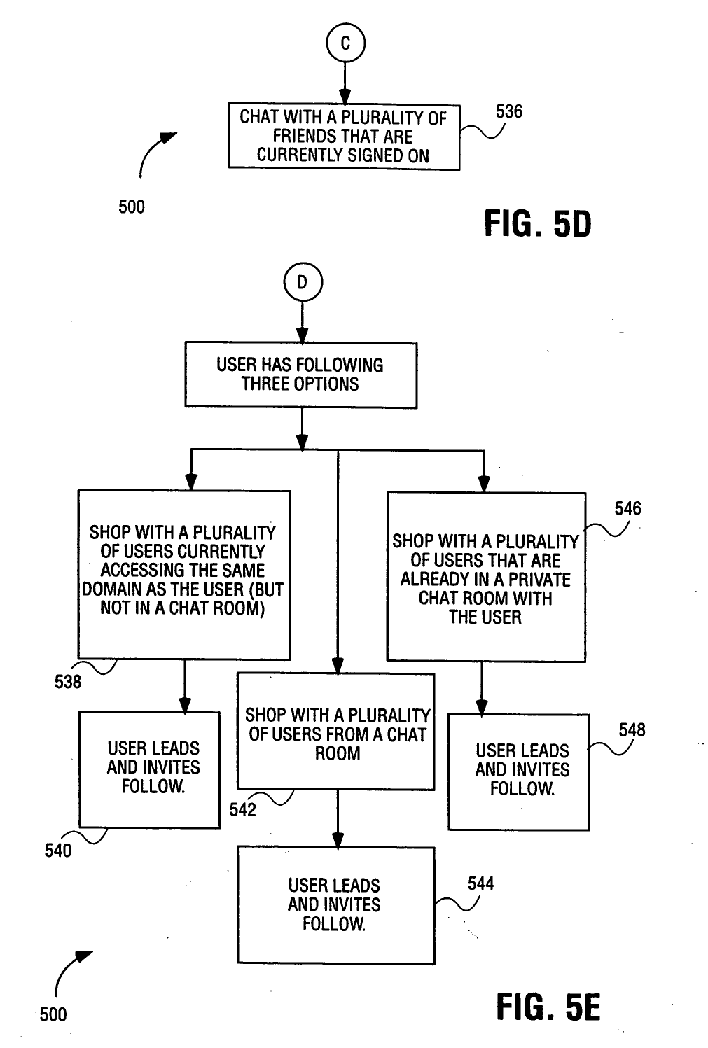

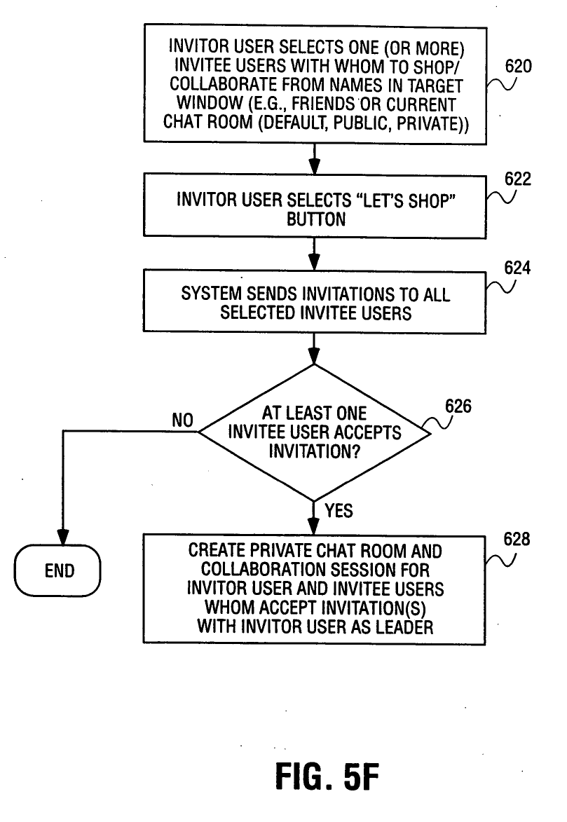

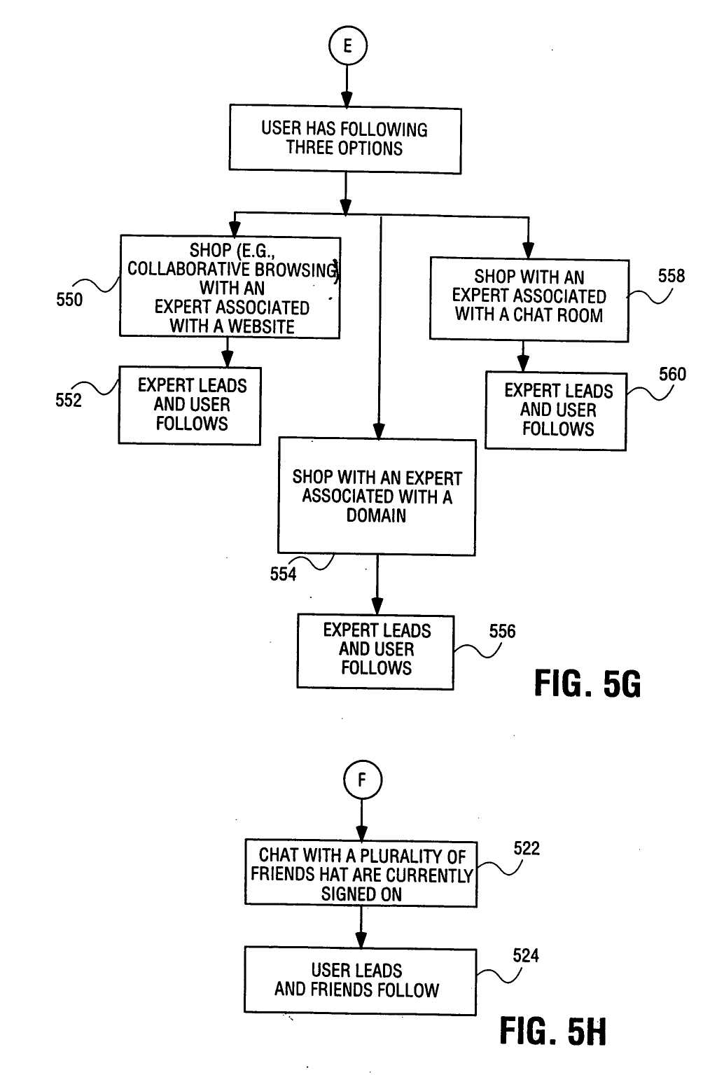

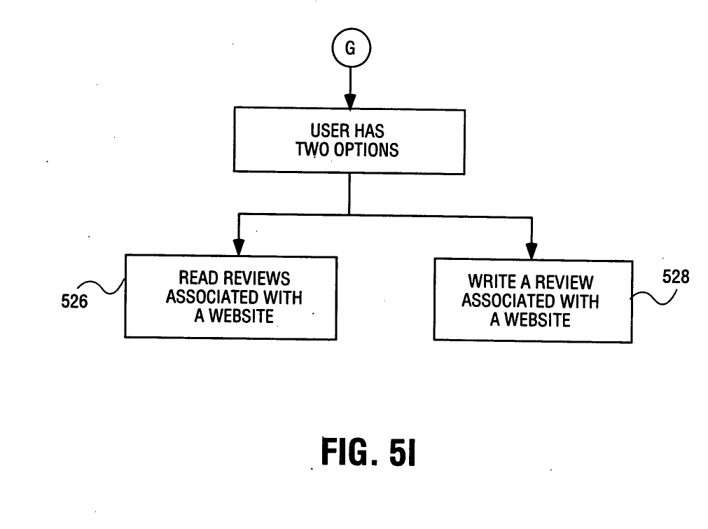

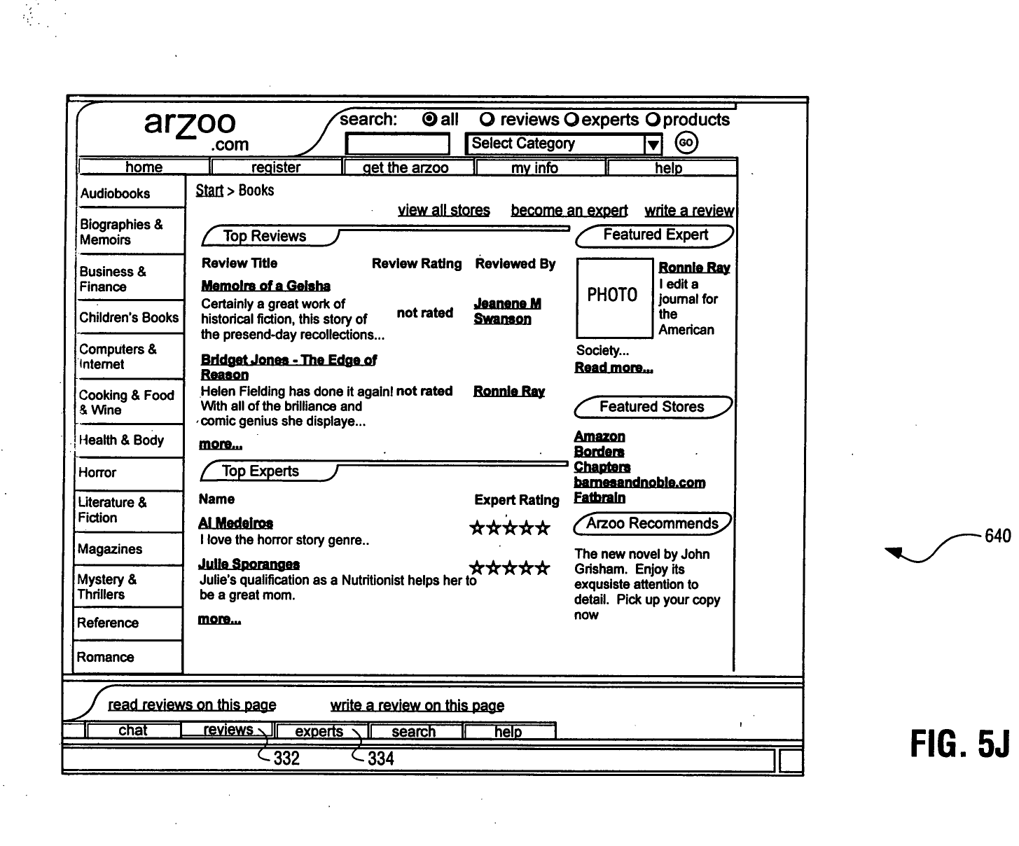

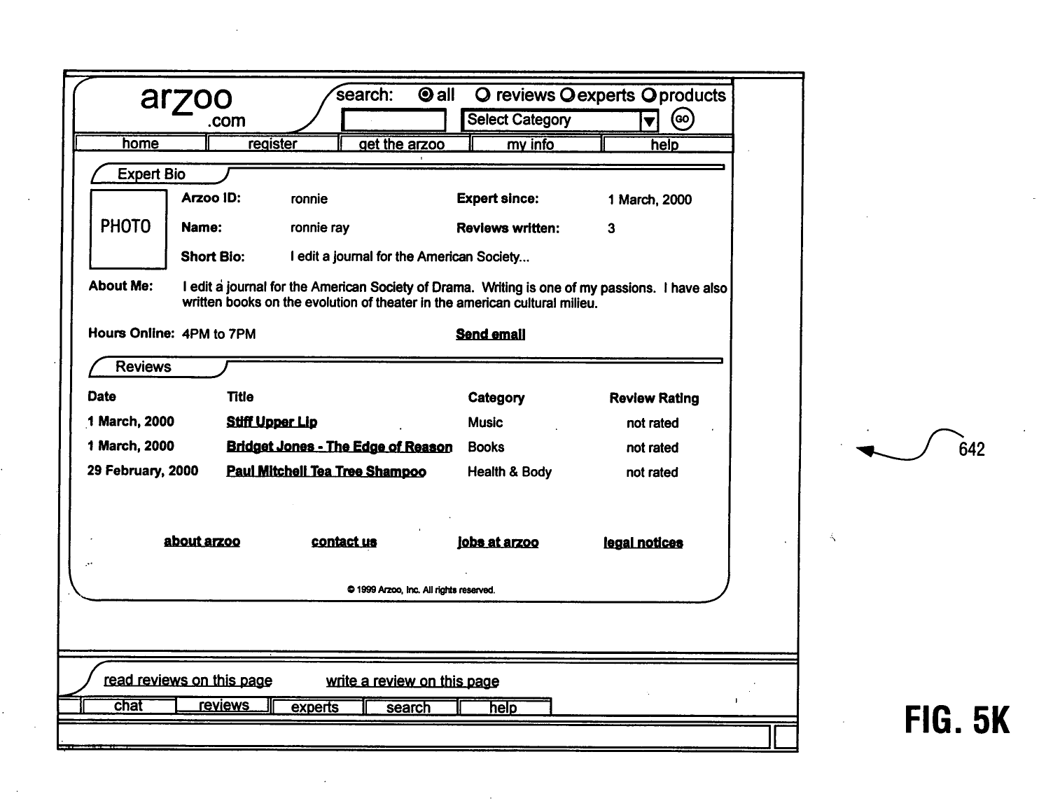

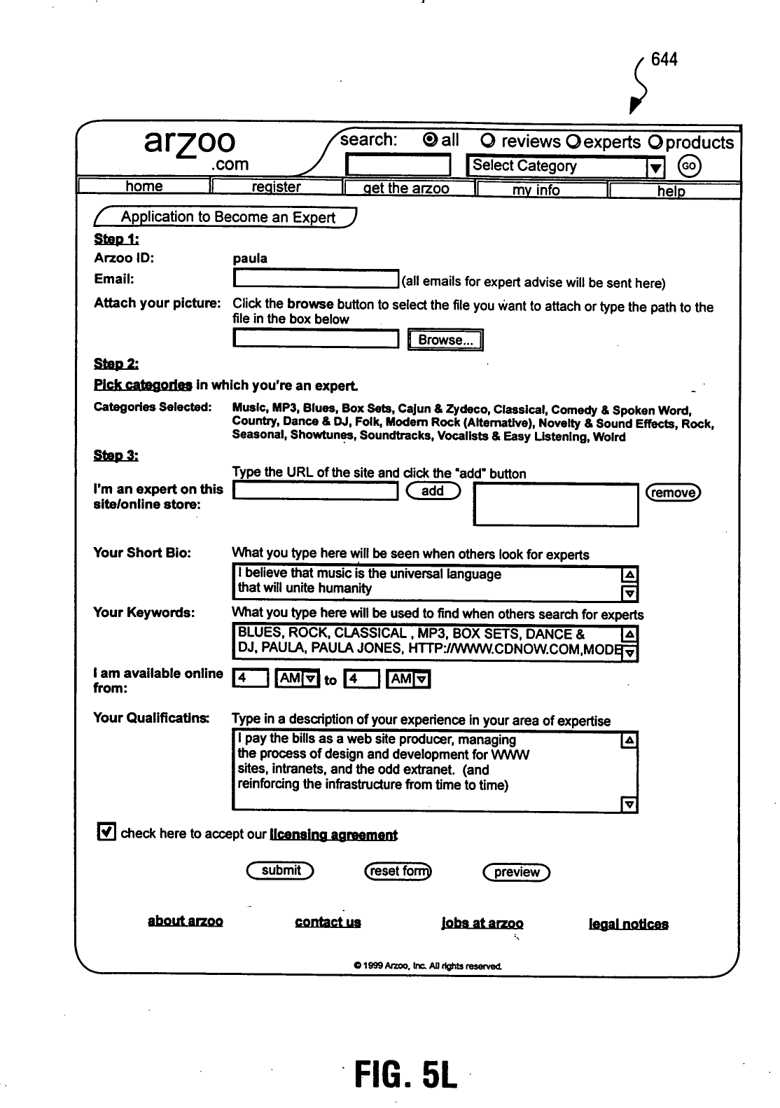

FIGS. 5A-5I illustrate flowcharts for an exemplary method 500 of interaction between the client machine 102 and the system 100. The services offered by the system are shown in detail.

As is apparent from the primary and interaction interfaces 300 and 204 shown in FIG. 3, the present invention contemplates that the system 100 will provide various services to a potential purchaser (e.g., a shopper or corporate purchaser) to assist the purchaser in making purchasing decisions. These services (or tools) may broadly be classified as a “reviews” service, an “experts” service and a “collaboration” service. In one embodiment, there is some overlap between the “experts” and “collaboration” services, as will become apparent from the below description.

The present invention is advantageous in that it allows these services to be applied across any number of network locations (e.g., websites), and is not restricted to any particular network location, website, or web domain. This advantage may, in one embodiment, be provided, as described above with reference to FIG. 2, by the auxiliary client component 104 (e.g., a web browser component) that identifies a network location being accessed by the primary client component 118, and communicates this to the interaction and review system 100. The system 100 is then able to provide the above-identified services with respect to the network location being accessed by the primary client component 118.

The method 500 discussed with reference to FIGS. 5A-5I commences at block 562 with user selection of the “chat” button 336 shown in FIG. 3 that, as described above, generates the expanded interaction interface 404 presented by the auxiliary client component 104. The expanded interaction interface 404 includes a chat window 444 via which a user can participate within a network-based chat session, a “chat room” window 448 that identifies a chat room in which a user is currently active, the “target” window 440 that, based on certain criteria, displays a list of targets (e.g., persons) with whom the person may communicate via the chat window 444. A “chat input” window 442 is also presented into which a user may type text, which is then communicated to all users logged into a specific chat room, identified in the “chat room” window 448 by user selection of the “send” button 446.

Returning to the method 500, at block 566, following a logon confirmation sequence at block 564, and prior to population of the interaction interface 404 with any information, the auxiliary client component 104 detects a network location (e.g., a web domain) that is currently being accessed by the primary client component 118. Specifically, the trap module 224, via the browser API 220, may capture the URL of a website currently being accessed by the primary client component 118 (e.g., a browser). The trap module 224 then communicates this URL to the system 100 by the Internet 106.

At block 568, the interaction and review system 100 uploads a list of “chat rooms” for the network location, or a domain, to the auxiliary client component 104 for display via the interaction interface 404 and specifically for inclusion within a drop-down menu for the “chat room” window 448. The auxiliary client component 104 automatically selects the “default room” as a chat room.

For example, a URL captured at block 566 may indicate that a user is accessing a web page on the website operated by Amazon.com, Inc. In this case, the system 100 uploads chat rooms specific to the “Amazon.com” domain. It will be appreciated that different domains may require different sets of chat rooms. For example, for an on-line retailer, a set of chat rooms focusing on product offerings by the on-line retailer will be offered. On the other hand, where the domain being accessed by the primary client component 118 is for a sports website (e.g., Quokka.com), a list of chat rooms may be uploaded, with each identified chat room focusing on a specific sport.

The list of chat rooms for a specific network location (e.g., domain) may be identified by the data server 114 that issues a query (e.g., a SQL query) against the database 116, and more specifically the domain table 900. A mapping of domains to a list of chat rooms may be recorded within the “chat rooms” column 924 of the domain table 900. The list of chat rooms retrieved from the domain table 900 is then returned to the auxiliary client component 104 for display within the drop down menu of the “chat room” window 448.

At block 570 of the method 500, the system 100 then uploads a list of users accessing the relevant domain and that are not within a specific chat room, and are accordingly regarded as being in the “default” room. Again, referring to the domain table in FIG. 9A, this table 900 records a mapping between (1) chat rooms for a specific domain and recorded within the “chat rooms” column 924 and (2) users within the “users” column 926 by issuing a query against the domain table 900. The data server 114 is accordingly able to identify, for users accessing a specific domain, which chat rooms associated with that domain respective users are participating in. Any users indicated in the “users” column 926, and not being associated with a specific chat room, are as a default placed in the “default room”.

Also, at block 570, the auxiliary client component 104 displays users identified within the uploaded list within the “target” window 440. Accordingly, a user, by entering text within the input window 442, may now communicate with all other users whose names, or identifiers, appear within the target window 440.

Having now entered a default chat room, at block 572, the user is presented with a number of options that may be exercised via the interaction interface 404 presented by the auxiliary client component 104.

At block 574, the user is presented with the option of chatting with a plurality of users. At block 576, the user may elect to commence a chat session with a single expert, at block 578 the user may elect to enter a chat session with any number of friends or “buddies” who are also currently online, at block 580 to collaboratively shop with a number of users, at block 582 to shop with at least one expert, at block 584 to shop with a plurality of friends, and at block 586 to read or write reviews pertaining to a specific network location. Each of these options will now be discussed in further detail below.

Turning now to FIG. 5B, should the user elect to chat with a plurality of users at block 574, the user may elect to chat with various groups of users who are currently accessing the relevant network location, or domain. At block 590, by not performing any further selections, the user may simply commence chatting with users that are within the “default room”. At block 594, the user may elect to commence a chat session with users who are currently accessing the relevant network location, or domain, and who are currently participating in a user-selected chat room. For example, by activating a drop-down menu for the “chat room” window 448, the user may select a further chat room to participate in (e.g., a chat room relating to a specific product or topic) in which case the selected chat room is communicated from the auxiliary client component 104 to the system 100, which then returns to block 570 to upload a list of users currently accessing the domain and participating within the chat room identified by the user.

At block 592, the user may elect to create a “private” chat room, that a number of further users are invited to participate within. This is done by selecting a target (or user) from the target window 440, and selecting the “Let's chat” button 452.

Turning to FIG. 5C, if a user elects to chat with an expert at block 576, the user has the option of commencing a chat session with an expert associated with a particular website that the user is currently accessing, at block 532 to establish a chat session with an expert associated with a domain that the user is currently accessing, and at block 534 to establish a chat session associated with a particular chat room. Specifically, by user selection of the “experts” button 434 presented within the interaction interface 404, a network location being accessed by the primary client component 118 is again communicated to the system 100. Further, the chat room in which the user is currently participating is also communicated to the system 100. By performing lookups on the domain table 900, the system 100 is able to identify experts associated with a particular website being accessed by the primary client component 118. Utilizing this information, a list of one or more experts associated with the relevant website, or a domain for a website, may be extracted from the table 900, and communicated through the primary client component 118 as a markup language document for display by the primary client component 118 in the primary interface 300.

Additionally, the list of experts may optionally be displayed within the target window 440, and the user may select an expert from this list with whom to commence a chat session.

With respect to block 532, the description provided above with respect to block 530 applies except in that experts are identified as being associated with a domain (as opposed to a website) and are thus identified with a lower resolution.

At block 534, by user selection of the “experts” button 458 associated with the target window 440, a user may elect to establish a chat session with an expert associated with the relevant chat room identified within the “chat room” window 448. Specifically, user selection of the “experts” button 458 will cause the current chat room in which the user is participating to be communicated to the system 100, which will then identify one or more experts, listed in the “experts” column 930 of the domain table 900, associated with the relevant chat room. A list of identified experts will then be communicated (e.g., as a XML file) to the auxiliary client component 104.

Turning to FIG. 5D, should the use elect at block 578 to establish a chat session with a plurality of friends, the auxiliary client component 104 communicates an identifier, identifying the user to the system 100 which then performs a lookup in the database 116, and specifically within a users table (not shown) to identify users that are recorded as being “friends” of the querying user, and that are communicated as being currently on-line. This list of friends is then returned to the auxiliary client component 104 for display within the target window 440. This function may be invoked by user-selection of the “buddies” button 460 associated with the target window 440.

Returning to FIG. 5E, if at block 580, the user elects to shop with a plurality of other users, there are three scenarios. Specifically, a user may elect to commence a collaborative shopping with a plurality of users by selecting the “let's shop” button 450 presented within the interaction user interface 404 generated by the auxiliary client component 104. User selection of the “let's shop” button 450 establishes a collaborative shopping session between the relevant user and any users whose names, or identifiers, appear within the target window 440.

Accordingly, at block 538, assuming that the user is participating within the “default room”, user selection of the “let's shop” button 450 will initiate a collaborative shopping session between the users within the “default room”.

Note that at block 540, the user that initiated the collaborative session leads with the invitees following.

The collaborative shopping session, whereby the user leads and the invitees follow, may be performed by having the trap module 224 of the auxiliary client component 104 identify network locations accessed by the primary client component 118, and communicate a network location identifier (e.g., a URL or directory path) for such network locations to the system 100, which in turn communicates such network location identifiers to load/navigate module 226 of primary client components 118 of the invitees.

At block 542, should a specific chat room be designated within the “chat room” window 448, the names associated with participants within this chat room will be displayed within the target window 440, and these users will then be invited to participate in a collaborative browsing session by user selection of the “let's shop” button 450. Similarly, at block 546, where the user is participating within a private chat room, user selection of the “let's shop” button 450 will establish a collaborative shopping session between the users within the target chat room.

FIG. 5F is a flow chart providing further details how a user may shop with a plurality of users at any one of blocks 538, 542 and 546, as shown in FIG. 5E.

At box 620, an invitor user selects one or more invitee users to collaboratively browse and shop. The invitee user may, in one embodiment be selected from names presented within the target window 440. It will of course be appreciated that the names listed in the target window 440 may be the names of users that are currently accessing the same domain, within a public chat room, or within a private chat room.

At box 622, having selected one or more names of invitee users within the target window 440, the invitor user selects the “let's shop” button 450, which causes the auxiliary client component 104 to communicate the names of the selected invitee users and a “let's shop” indication to the system 100.

At block 624, the system 100, utilizing the list of invitee users received from the auxiliary client component 104, generates and sends collaborative browsing (or shopping) invitations to all selected invitee users. These invitations may be in the form of e-mails, or pop-up windows, that are presented by the auxiliary client component 104.

At decision box 626, a determination is made as to whether at least one invitee user has accepted an invitation issued at block 624. For example, an invitee user may click through a link provided in an invitation e-mail, or may positively respond to a pop-up window presented by the auxiliary client component 104.

Following a positive determination at decision block 626, at block 628, the system 100 establishes a private chat room and collaboration session for the invitor user and one or more invitee users who accepted the invitations. The collaborative session establishes the invitor user as a leader for the purposes of collaborative shopping.

Alternatively, should none of the invitees accept the invitation issued at block 624, the method then ends at block 630.

FIG. 5G illustrates the operation performed to collaboratively browse, or shop, with an expert.

The methodology here is substantially the same as described above with reference to FIG. 5C except that, as opposed to establishing only the chat session, a chat session with conjunction with a collaborative browsing session is established. The manner in which a collaborative, or browsing, session is established between an invitor user and an invitee expert is substantially similar to that described above with reference to FIG. 5F, but differs in that the invitor user is installed as a follower, whereas the invitee leader is established as a leader within the context of the collaborative browsing or shopping session.

FIG. 5H illustrates the operations performed to establish a chat and collaborative browsing session between friends or “buddies” when a user elects the “let's shop” button 450 when a number of “buddies” or friends that are listed within the target window 440 as a result of prior user selection of the “buddies” button 460.

FIG. 5I illustrates the operation performed when a user elects to read or write reviews associated with a network location (e.g., a URL, directory path or domain) accessed by the primary client component 118. Specifically, at block 526, the user may read reviews associated with a particular network location (e.g., a website) being accessed by the primary client component 118.

More specifically, upon user selection of the “reviews” button 432 within the interaction interface 404 presented by the auxiliary client component 104, the trap module 224 traps an identifier (e.g., a URL) identifying the network location. This is communicated by the Internet 106 back to the system 100 that performs a lookup within the domain table 900 to locate reviews, recorded within the “reviews” column 928, associated with a particular website or a domain. The list of reviews is then communicated via the data server 114 to the web servers 112, that generate a markup language document for communication by the Internet 106 to the primary client component 118 for display.

Again, as a network location identifier (e.g., a URL or directory path) is captured and communicated to the system 100, the system 100 is not able to maintain reviews across a wide variety of websites in a domain-independent manner.

The reviews may pertain to a product regarding which information is retrieved from the relevant network location (e.g., a web page describing a particular product) or may pertain to the domain itself (e.g., a rating or review of a website) or may pertain to other content retrieved from the relevant network location (e.g., an article or the like).

At block 528, the user has the option of writing a review associated with a web page. Again, the auxiliary client component 104 captures and communicates a network location identifier, identifying a network location being accessed by the primary client component 118 to the system 100. The system 100, via the web servers 112 then presents the user with a review form, within the primary interface 300 presented by the primary client component 118. By completing this review form, the contents of which are communicated back to system 100, the system 100 is able to associate the review with the network location previously captured and communicated from the auxiliary client component 104.

FIG. 5J shows an exemplary “reviews and experts” interface 640, that may, for example, be invoked by user selection of the “reviews” or “experts” buttons 332 or 334 presented within the interaction interface 304. The interface 640 presents a listing of “top reviews” and “top experts” with respect to a particular topic, domain, website (e.g., identified by a specific URL) or a chat room.

FIG. 5K shows an exemplary “expert biography” interface 642 which may, in one embodiment, provide biographical details regarding a particular expert, as well as a listing of reviews that may have been authorized by the relevant expert.

FIG. 5L shows an “application to become an expert” interface 644, utilizing which an expert may submit pertinent information to the system 100.

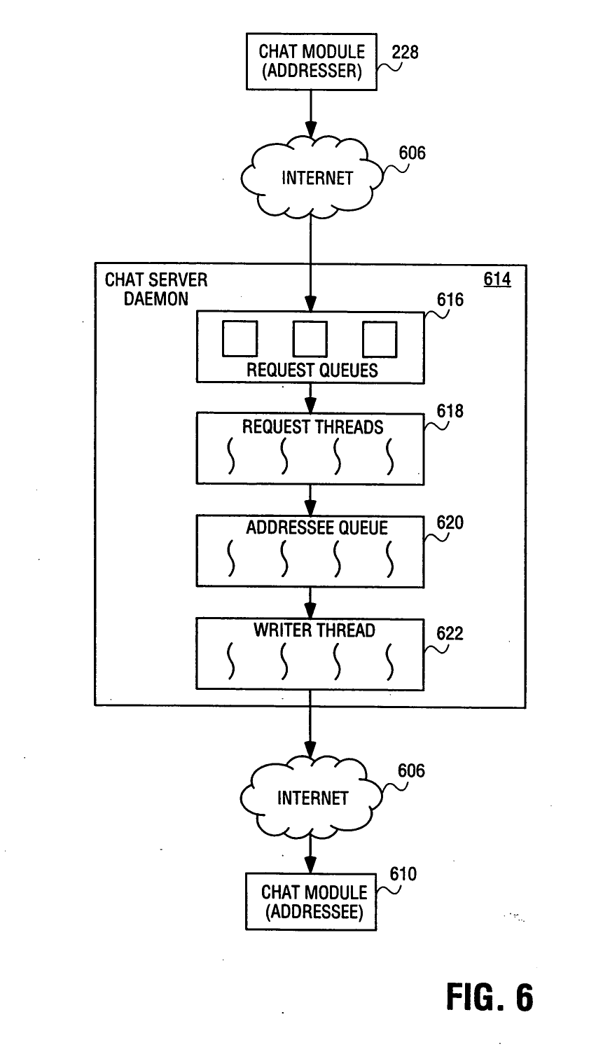

FIG. 6 is a block diagram illustrating further details regarding the architecture of an exemplary chat server daemon 614 that forms part of each chat server 108 of the interaction and review system 100. FIG. 6 illustrates a chat server daemon 614 communicating, via the Internet 606, with a chat module 228 included within, for example, the auxiliary client component 104 hosted on a client machine 102.

The chat server daemon 614 responds to communication requests (e.g., request messages typed into the input window 442) received from the chat module 228, and directed towards one or more further users (e.g., a friend, an expert or a chat room user).

The chat server daemon 614 is shown to maintain a number of request queues 616 for incoming communication requests received from multiple chat modules 228. The use of multiple request queues 616 is advantageous in that it provides scalability and allows for a request load to be balanced.

A number of threads 618 service the request queues 616, and in one embodiment, extract requests on a first-in first-out (FIFO) basis from the first request queues 616, and place these requests into appropriate addressee queues 620. Each of the reader threads 618 further has a “multicast” capability, and is capable of communicating a single communication request, addressed to multiple addressees, to multiple addressee queues 620.

A pool of writer threads 622 then services the addressee queues 620, and extracts communication requests from these addressee queues 620 and directs them to the appropriate chat modules 610 of the addressees via the Internet 606.

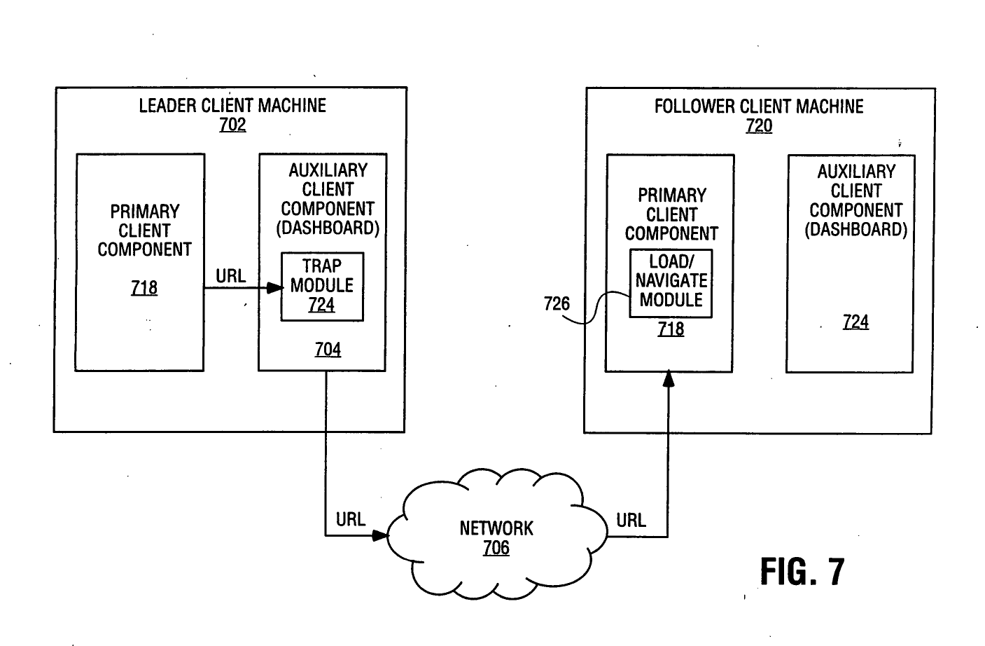

The concept of leader and follower mentioned in FIGS. 5E-5I is now explained with reference to FIG. 7. Typically, the user that invites another user to shop collaboratively becomes the leader. The invitee user becomes the follower. There is an exception when the invitee user is an expert. In this case, the invitee expert user becomes the leader. The network location accessed by the primary client component 718 of the leader's client machine 702 is automatically loaded on to the primary client component 728 of the follower's client machine 720. This is accomplished by the trap module 724 located in the auxiliary client component 704 of the leader's client machine 702 capturing the URL address of the network location accessed by the primary client component 718 of the leader's client machine 702. The leader's auxiliary client component 704 communicates via the Internet 706 the captured URL address to the load/navigate module 726 of the primary client component 728 of the follower's client machine 720 for accessing the network location.

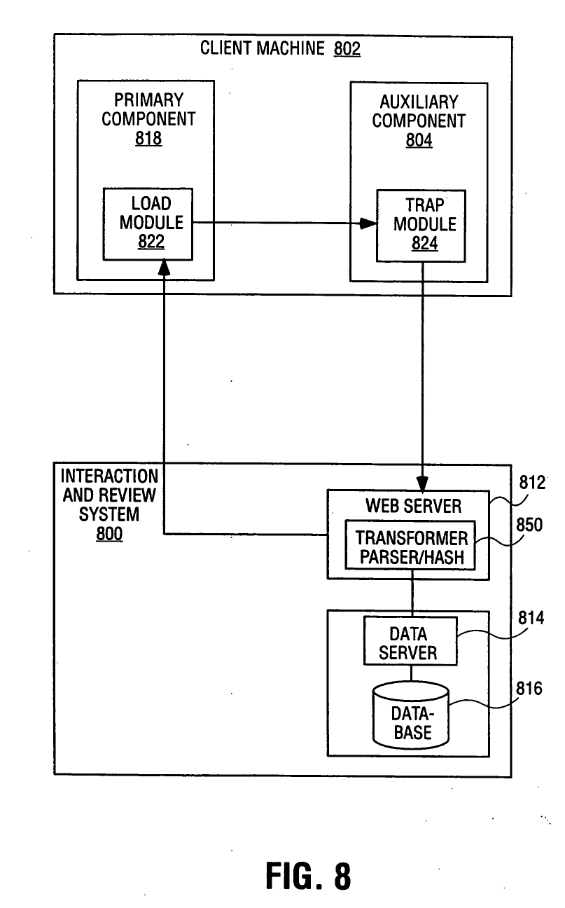

FIG. 8 illustrates an exemplary block diagram of the system 100 for sending reviews upon request from the client machine 802 and receiving reviews for storage from the client machine 802. The attributes and composition of the client machine 102 has been previously described with references to FIGS. 2 and 7.

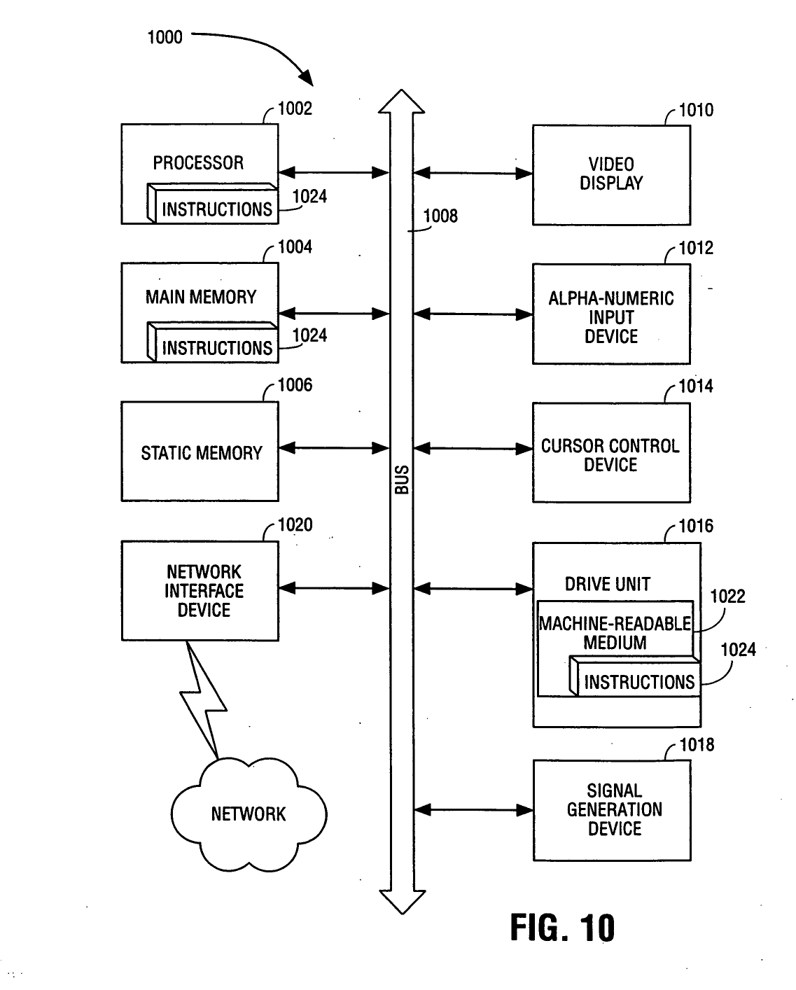

FIG. 10 shows a diagrammatic representation of machine in the exemplary form of a computer system 1000 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1000 includes a processor 1002, a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alpha-numeric input device 1012 (e.g. a keyboard), a cursor control device 1014 (e.g. a mouse), a disk drive unit 1016, a signal generation device 1018 (e.g. a speaker) and a network interface device 1020.

The disk drive unit 1016 includes a machine-readable medium 1022 on which is stored a set of instructions (i.e., software) 1024 embodying any one, or all, of the methodologies described above. The software 1024 is also shown to reside, completely or at least partially, within the main memory 1004 and/or within the processor 1002. The software 1024 may further be transmitted or received via the network interface device 1020. For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals.

Thus, a network-based interaction review service for facilitating purchasing advise and information in a network-based commerce environment have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method for navigating a network including:
identifying a first network location accessed by a first client operated by a first user, wherein the identification is performed utilizing an identifier, identifying the first network location, communicated to an interaction system from the first client;
identifying a second user associated with the first network location; and
commencing a communications session with the second user via the interaction system.

2. The method of claim 1 wherein the identifying of the second user includes accessing data recording respective associations of a plurality of users with a plurality of network locations, identifying the first network location from among the plurality of network locations indicated by the data and identifying the second user as being associated with the first network location from the data.

3. The method of claim 1 wherein the second user is associated with the first network location by a registration of the second user as an expert with respect to the first network location.

4. The method of claim 1 wherein the second user is associated with the first network location by a current access session to the first network location.

5. The method of claim 1 wherein the first network location is a World Wide Web domain.

6. The method of claim 1 wherein the first network location is identified by a Uniform Resource Locator.

7. The method of claim 1 wherein the communications session is any one of a group including a voice-based chat session, a text-based chat session and an application sharing session.

8. The method of claim 1 wherein the communications session is a collaborative interaction session between the first user and the second user.

9. The method of claim 8 wherein the first and second clients operate as respective leader and follower clients within the collaborative interaction session, or vice versa.

10. The method of claim 8 wherein the collaborative interaction session is a collaborative shopping session.

11. The method of claim 8 wherein the collaborative interaction session is a collaborative guidance session.

12. The method of claim 1 including trapping the identifier, identifying the first network location accessed by the first client, at the first client for communication to the interaction system.

13. The method of claim 12 wherein the first client includes a capture component to trap the identifier identifying the first network location accessed by the first client.

14. The method of claim 1 including trapping a further identifier, identifying the first network location accessed by the second client, at the second client for communication to the interaction system so as to enable the interaction system to associate the second client with the first network location.

15. The method of claim 14 wherein the second client includes a capture component to trap the further identifier identifying the first network location accessed by the second client.

16. The method of claim 9 wherein the leader client communicates a lead identifier, identifying an accessed network location accessed by the lead client, to the follower client, responsive to which the follower client accesses the accessed network location.

17. The method of claim 16 wherein the lead identifier identifying the accessed network location is communicated between the leader and follower clients via the interaction system.

18. The method of claim 17 wherein the capture component comprises any one of a group including an ActiveX control and a Java applet.

19. The method of claim 13 wherein the capture component is written in a C++ programming language.

20. The method of 13 wherein the capture component is implemented as an explorer bar.

21. The method of claim 13 wherein the capture component can automatically activate itself when a client browser is opened.

22. The method of claim 3 automatically compensating the second user for facilitating a sale at the first network location.

23. The method of claim 22 wherein the automatic compensation of the second user includes communicating a user identifier for the second user to the first network location.

24. The method of claim 23 wherein the first network location communicates transaction information, including the user identifier for the second user, to the interaction system to facilitate the automatic compensation of the second user.

25. The method of claim 4 including receiving an interaction ranking of the second user by the first user at the interaction system.

26. A method for navigating a network including:
identifying a review data location associated with a first network location accessed by a first client operated by a first user, wherein the review data is identified utilizing an identifier identifying the first network location received from the first client via a network;
communicating the review data location to the first client via the network.

27. The method of claim 26 wherein the identifying of the review data location includes accessing data recording respective associations of a plurality of review data with a plurality of network locations, identifying the review data location from among the plurality of review data locations indicated by the data and identifying the review data location as being associated with the first network location from the data.

28. The method of claim 26 including trapping the identifier, identifying the first network location accessed by the first client, at the first client for communication to a review system.

29. The method of claim 28 wherein the first client includes a capture component to trap the identifier identifying the network location accessed by the first client.

30. The method of claim 26 including communicating the review data stored at the review data location to the first client responsive to a request to access the review data location received from the first client via the network.

31. The method of claim 26 wherein the first network location is any one of a group including Uniform Resource Locator and a directory path.

32. The method of claim 26 wherein the review data is authored by a second user.

33. The method of claim 32 wherein the second user is associated with the first network location by a registration of the second user as an expert with respect to the first network location.

34. The method of claim 32 wherein the second user is compensated automatically if the review data location is accessed by the first client for a certain predetermined duration.

35. The method of claim 26 wherein the review data is stored in a database of the review system.

36. The method of claim 26 wherein a plurality of the review data is associated with the first network location.

37. A method for navigating a network including:
receiving from a first client component a first network location accessed by a first client operated by a first user;
identifying utilizing an interaction system an identifier identifying a second user associated with the first network location, communicating the identifier to the first client component; and
facilitating a communications session between the first user and the second user upon request from the first or second users.

38. A method for shopping on a network including:
receiving from a first client an identifier identifying a first network location accessed by a first client operated by a first user;
receiving from the first client a review data associated with the first network location, the review data being authored by the first user;
storing into a review data location the review data; and
associating the review data location with the first network location.

39. The method of claim 38 including trapping the identifier, identifying the first network location accessed by the first client, at the first client for communication to a review system.

40. The method of claim 39 wherein the first client includes a capture component to trap the identifier identifying the first network location accessed by the first client.
